(19) United States
(12) Patent Application Publication
(10) Pub. No.: US 2004/0265751 A1
(43) Pub. Date: Dec. 30, 2004

(54) Method of manufacturing a stamper, master plate, support structure and use of such a stamper

(76) Inventor: Petrus Helena Gerardus Maria Vromans, Eindhoven (NL)

Correspondence Address: US Philips Corporation, Intellectual Property Department, PO Box 3001, Briarcliff Manor, NY, 10510, US

(21) Appl. No.: 10/495,284

(22) PCT Filed: Oct. 22, 2002
(86) PCT No.: PCT/IB02/04408

(30) Foreign Application Priority Data
Nov. 16, 2001 (EP) 01204391.5

(51) Int. Cl. B29D 17/00; B44B 5/00

(52) U.S. Cl. 430/321; 430/320; 264/1.33; 101/4

(57) ABSTRACT

A description is given of a method of manufacturing a stamper for use in the manufacture of Small Form Factor (SFF) optical data storage media. A conventional master plate (2) is provided with a series of areas with spiral- or concentric-shaped information tracks (3a-3h), having a relief structure, with the center of each area (3a-3h) being located outside the axis of rotation (9) of the master plate (2). This is done by using a conventional master recorder and a separate master plate support structure (1) without the necessity for complex movements of the master recorder writing head. The master plate (2) thus obtained is used to produce the stamper, containing a negative replica of the surface of the master plate (2).

The invention relates to a method of manufacturing a stamper for use in the manufacture of optical data storage media, in which method a master plate, comprising a substrate with an axis of rotation and a radiation beam sensitive recording layer provided thereon, is exposed to a modulated radiation beam, and in which method a series of areas with spiral- or concentric-shaped information tracks, having a relief structure, is formed in the recording layer with the center of each area being located outside the axis of rotation of the master plate, and subsequently the stamper, in which the relief structure of the information tracks of the master plate is copied, is formed on said master plate and separated from the master plate.

The invention further relates to a master plate produced in said method.

The invention further relates to a support structure for use in said method.

The invention further relates to the use of such a stamper produced in said method.

A method of the type mentioned in the opening paragraph is known from European Patent Application EP 0 355 925 A1.

Optical data storage media with optically readable, e.g. digital, information are generally provided with a spiral-shaped track consisting of reflecting and non-reflecting, or at least less reflecting, areas or “pits”, formed in relief in the synthetic plastics material of the substrate of the optical information medium, and beginning a short distance from the edge of the carrier, or in the center thereof. The spiral-shaped track terminates a short distance from the center of the optical information medium, or adjacent to the edge thereof. This track can be scanned by means of a radiation beam, e.g. a laser beam, to provide a series of digitized pulses which, in turn, can be converted into image, sound, or data, e.g. text. The optical data storage media are commonly made in large numbers by an injection molding process. In this process, a stamper, containing the negative of relief structure to be impressed in the substrate of the optical disk medium, is positioned in a mold of an injection molding apparatus. It is of great importance that the disk-shaped stamper has as long a service life as possible and that the injection molding process has as short a cycle period as possible. According to said European patent application a method having a considerably shorter cycle period is described by forming on said master plate four spiral-shaped information tracks with the center of each spiral-shaped track being located outside the center of said master disk and subsequently making from said master plate a disk shaped nickel negative replica also called a stamper. In this way the cycle period of the injection molding process, per optical storage medium, will be reduced by a factor of about 4, while of course the maximum diameter of the resulting optical storage medium is limited. However, such medium may have a higher information density per unit area, because the edge and center areas, which in conventional optical information medium are usually unsuitable for use on the ground of inferior reflection characteristics and the necessity for a relatively large center hole, can be used. This is because the center and edge portions of the information media do have the same homogeneity concerning optical characteristics due to their off-center location on the master plate. In fact, the series of spiral-shaped information tracks can be provided in the annular area located between the edge and the center of the conventional optical information medium, which area has the desired reflection characteristics. The provision of a single spiral-shaped information track on a circular master plate, from the edge thereof to the center, or the other way around, is mechanically relatively simple. The master plate can be caused to rotate and the “writing head” for providing the information track can be driven with a uniform speed according to a radial line containing the center of the master plate.

However, it is a disadvantage of the known method that the provision of a series of areas with spiral-shaped information tracks on a standard master plate, where the center of each area is outside the center of the master plate is extremely complicated, because the spiral movement can no longer be split or divided over master plate and “writing head” of the master recorder. The “writing head” itself has to be driven in accordance with a complex spiral-shaped movement. This movement is not possible with a standard master recorder. To overcome this problem, the known method from said European patent application uses a special master plate, which can be formed as a composite part, consisting of four separate disks, of the size of the ultimate optical information medium, fitted in a circular holder having recesses therein for receiving the four separate disks. These separate disks each have to be mastered separately in a conventional way. It may be clear that using a master plate comprising several parts is disadvantageous. Firstly, no standard master plate can be used; secondly the positioning of four separate disks in recesses gives rise to slits or grooves, which may have a unfavorable effect, e.g. inhomogeneous layer thicknesses, during the formation process of the stamper; and thirdly such a special master plate is more expensive.

It is therefore an object of the present invention to provide a method of the kind described in the opening paragraph, in which a standard master plate is provided with a series of areas with spiral-shaped or concentric-shaped information tracks, as described in the opening paragraph, in a simple manner with a standard mastering recorder.

According to the invention this object is achieved with a method, which is characterized in that

a) during exposure of the recording layer to the modulated radiation beam, the master plate is fixed eccentrically with respect to an axis of rotation of a support structure, the axis of rotation of the support structure being substantially perpendicular to the surface of the substrate of the master plate, and the support structure with attached master plate is rotated along the axis of rotation of the support structure;

b) a first area of the series of areas is exposed to the radiation beam, forming information tracks, while the center of the first area coincides with the axis of rotation of the support structure;

c) the master plate is released from the support structure, moved relatively to the support structure until the center of a subsequent area coincides with the axis of rotation of the support structure and fixed again to the support structure;

d) the subsequent area is exposed to the radiation beam, forming information tracks;

e) steps c) and d) are repeated until all areas of the series of areas are exposed to the radiation beam.

By using said method a conventional standard master plate may be provided with several areas with information tracks, as described in the opening paragraph, using a conventional master recorder. By placing the conventional master plate eccentrically on a support structure several areas may be exposed subsequently. The exposure of the subsequent areas is performed in the same way as on a standard master plate and modification of the conventional mastering recorder in not required. Said areas correspond to the information areas of the ultimate optical media. It should be noted that the term master plate does include circular master disks, which are most commonly used, but also includes other shapes of master plates. Presently, the interest in small optical storage media is growing. Such small optical media, in the disk embodiment, may be referred to as Small Form Factor (SFF) Optical Disks. These disks are becoming more and more important as storage media in consumer imaging, sound and communication devices such as digital camcorders, digital still picture cameras, digital audio players and cellular phones etc., in which devices the size of the storage media obviously is an important feature. The method according to the invention is excellently suited for providing a master plate for producing a stamper for the production of SFF optical disks.

In a preferred embodiment of the method, in step c), the master plate is rotated around the axis of rotation of the master plate and the axis of rotation of the master plate is present at a fixed position on the support structure. This has the advantage that, during rotation of the master plate, the central chuck of a standard master plate may be used as a centering means to a receiving holder of the support structure. After rotation around this chuck the master plate may be fixed relatively to the support structure e.g. by known vacuum techniques.

In another preferred embodiment of the method the master plate is rotated n−1 times an amount substantially equal to 360/n degrees and n is an integer number larger than 1. In this way a rotation-symmetrical set of said areas is produced on the master plate and subsequent stamper. This has the advantage that it facilitates further processing of the stamper and the injection molded substrate containing several SFF optical disks, which still have to be cut out. Normally, during deposition, e.g. sputtering, of metal reflection layers on the injection-molded substrate, a mask is used in order to prevent deposition of metal at the outer edge, typically about 1 mm, of the substrate. The purpose of this is to prevent corrosion of the metal adjacent the outer edge. Because, when the outer edge of the substrate is free from metal, the protective cover layer, which is applied after deposition of the metal layer, contacts the substrate thereby completely sealing the metal layer from the outer environment. In case of multiple SFF disks per substrate, the masking has to be done at the “outer edge” of the SFF disk, which is still present and uncut inside the larger substrate. When the tangential and radial location of these SFF disks is exactly defined it is relatively simple to design a sputtering masking tool for masking the “outer edges” of the SFF disks. This is exactly what is achieved when using the method of this embodiment. Further, e.g. a cutting tool may be used in which a first SFF optical disk is cut out after alignment and subsequently the substrate is rotated n−1 times an amount of 360/n degrees while cutting the subsequent disks.

Especially suitable is the use of a master plate, which has a diameter in the range of 150-170 mm and the diameter of the areas for recording spiral- or concentric shaped information tracks is smaller than 40 mm. As standard master plate has a diameter of 160 mm and is provided with said areas having a diameter of e.g. 30 mm. A diameter smaller than 40 mm is likely to become a suitable size for SFF optical disks. For a master plate of 160 mm it is advantageous when n is one of the numbers 8, 9 and 10, e.g. 8, and the axis of rotation of the master plate on the support structure has a distance of 30-55 mm, e.g. 43 mm, to the axis of rotation of the support structure.

In this way an optimal maximum number of areas can be provided in an annular zone on the master plate.

A preferred embodiment of a support structure suitable for use in the method is characterized in that the support structure comprises at least one counterweight in order to counterbalance the mass of an attached master plate so that the center of gravity of the assembly of the support structure and the attached master plate substantially coincides with the axis of rotation of the support structure. Since the support structure is to be rotated by the master recorder at a rotation speed, which may be considerably high, e.g. more than 300 RPM, it is advantageous to have a balanced assembly of support structure and attached master plate. By balanced is meant statically balanced or statically/dynamically balanced. A balanced assembly prevents unwanted vibrations and forces during the recording, which may cause deviations in the written tracks.

In another preferred embodiment of the support structure the counterweight is movable with respect to the axis of rotation of the support structure. This has the advantage that small deviations in the mass of the master plate can be compensated for by moving the counterweight slightly and thus adjusting the center of gravity of the assembly to the desired position, i.e. the axis of rotation of the support structure.

In yet another embodiment of the support structure the counterweight is detachable from the support structure. When a new type of master plate is introduced, which may have a mass which deviates considerably from the standard master plate it may be required to replace the counterweight by another counterweight having a larger or smaller mass. Merely moving the counterweight may not be sufficient in order to compensate for these large deviations.

An embodiment of an assembly of support structure and master plate for performing the method according to the invention will be described with reference to the drawings. It should be noted that drawings are schematic.

In the Drawings:

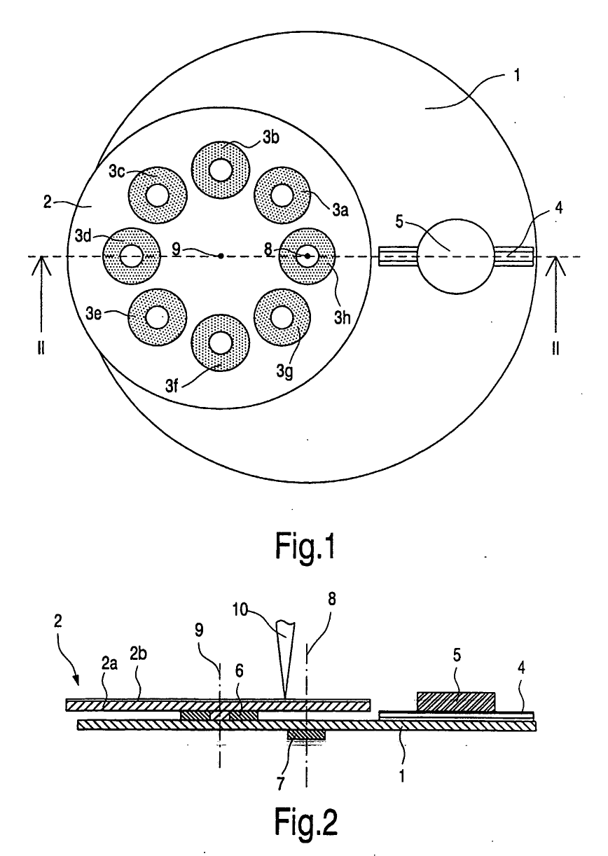

FIG. 1 schematically shows a top view of an embodiment of an assembly of the support structure and master plate for performing the method according to the invention;

FIG. 2 shows a cross sectional view of the embodiment of FIG. 1, taken along II-II in FIG. 1.

In FIGS. 1 and 2 the assembly of the support structure 1 and master plate 2 for performing the method of manufacturing a stamper for use in the manufacture of optical data storage media is shown. The master plate 2 comprises a substrate 2a, made of glass, and a radiation beam sensitive recording layer 2b provided thereon. The recording layer 2b is exposed to a modulated radiation beam 10. A series of areas 3a-3h with spiral- or concentric-shaped information tracks, having a relief structure, is formed in the recording layer 2b with the center of each area 3a-3h being located outside the axis of rotation 9 of the master plate. The following steps are comprised in the method according to the invention:

a) during exposure of the recording layer 2b to the modulated radiation beam 10, the master plate 2 is fixed eccentrically with respect to an axis of rotation 8 of the support structure 1. The axis of rotation 8 of the support structure 1 is substantially perpendicular to the surface of the recording layer 2b of the master plate 2. The support structure 1, together with the fixed master plate 2, is rotated along the axis of rotation 8,

b) a first area 3a of the series of areas 3a-3h is exposed to the radiation beam 10, forming an information track, while the center of the first area 3a coincides with the axis of rotation 8 of the support structure 1,

c) the master plate 2 is released from the support structure 1, rotated an amount of 45 degrees, around an axis of rotation 9 of the master plate 2, relatively to the support structure 1 until the center of a subsequent area 3b coincides with the axis of rotation 8 of the support structure 1. The axis of rotation 9 of the master plate is present at a fixed position on the support structure 1. Then the master plate 2 is fixed again to the support structure 1,

d) the subsequent area 3b is exposed to the radiation beam 10, forming an information track, while the center of the subsequent area 3b coincides with the axis of rotation 8 of the support structure 1,

e) steps c) and d) are repeated until all 8 of the series of areas 3a-3h are exposed to the radiation beam 10.

It should be noted that in FIG. 1 all areas 3a-3h have been exposed and the center of the last exposed area 3h coincides with the axis of rotation 8 of the support structure 1.

The master plate 2 is circular and has a diameter of 160 mm and the diameter of the areas 3 with spiral- or concentric shaped information tracks is 30 mm. The axis of rotation 9 of the master plate 2 on the support structure 1 has a distance of 43 mm to the axis of rotation 8 of the support structure 1.

Subsequently, the surface of the radiation beam sensitive recording layer 2b of the master plate 2 is provided with a conductive metal layer, preferably nickel, of about 50-100 nm by known deposition techniques, e.g. sputtering or wet electroless nickel deposition. Once metalized, the master plate 2 is ready for use in an electro-forming process of creating a nickel stamper. The information tracks with data pits in the areas 3a-3h of the master plate 2 are precisely replicated in the electro-forming process as nickel ions are gradually deposited over the conductive surface of the master plate 2. The process of electro-forming a stamper on a master plate 2 is well known in the art. With present technology, this process takes approximately one hour. After the desired stamper thickness is achieved (determined by a current/time/deposition rate calculation according to Faraday's law), the master plate 2 and stamper are removed from the electro-forming galvanic cell. Subsequently, the nickel stamper is separated from the surface of the master plate 2. The nickel stamper is a negative copy of the master plate 2. Possible residues of the recording layer 2b on the surface of the stamper are removed by known cleaning techniques. If the metal layer is not nickel it preferably is removed by dissolving it with a selective etching agent. The stamper thus obtained is also known as a father stamper. This father may be used directly in an injection molding apparatus for molding plastic substrates containing again a positive copy of the information tracks. Alternatively it is possible to repeat the electro-forming process and again produce a negative copy of the surface of the father stamper called a mother stamper which in its turn is used to produce a so-called son stampers, which ultimately are placed in an injection molding apparatus. In this way a plurality of son stampers is obtained from one father stamper, so that more optical storage medium substrates may be produced than would be possible with the single father stamper only. Furthermore it provides the possibility of producing back-up son stampers in case of failure or damage of one of the son stampers.

In FIGS. 1 and 2 the support structure 1 comprises a counterweight 5 in order to counterbalance the mass of an attached master plate 2, so that the center of gravity of the assembly of the support structure 1 and the attached master plate 2 substantially coincides with the axis of rotation 8 of the support structure 1.

The counterweight 5 is movable with respect to the axis of rotation 8 of the support structure 1. In this embodiment the counterweight 5 is also detachable from the support structure 1 by e.g. unscrewing it from a sledge 4.

The support structure 1 has a centering unit 6 for receiving a master plate 2. Further the support structure 1 has a chuck 7 which is used to center the support structure on a mastering recorder.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising”, “comprise” or “comprises” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a method of manufacturing a stamper for use in the manufacture of optical data storage media is provided. A conventional master plate is provided with a series of areas with spiral- or concentric-shaped information tracks, having a relief structure, with the center of each area being located outside the axis of rotation of the master plate. This is done by using a conventional master recorder and a separate master plate support structure without the necessity for complex movements of the master recorder writing head.

1. A method of manufacturing a stamper for use in the manufacture of optical data storage media, in which method a master plate (2), comprising a substrate (2a) with an axis of rotation (9) and a radiation beam sensitive recording layer (2b) provided thereon, is exposed to a modulated radiation beam (10), and in which method a series of areas (3a-3h) with spiral- or concentric-shaped information tracks, having a relief structure, is formed in the recording layer (2b) with the center of each area (3a-3h) being located outside the axis of rotation (9) of the master plate (2), and subsequently the stamper, in which the relief structure of the information tracks of the master plate (2) is copied, is formed on said master plate (2) and separated from the master plate (2), characterized in that
a) during exposure of the recording layer (2b) to the modulated radiation beam (10), the master plate (2) is fixed eccentrically with respect to an axis of rotation (8) of a support structure (1), the axis of rotation (8) of the support structure (1) being substantially perpendicular to the surface of the substrate (2a) of the master plate (2), and the support structure (1) with attached master plate (2) is rotated along the axis of rotation (8) of the support structure (1);
b) a first area (3a) of the series of areas (3) is exposed to the radiation beam (10), forming an information track, while the center of the first area (3a) coincides with the axis of rotation (8) of the support structure (1);
c) the master plate (2) is released from the support structure (1), moved relatively to the support structure (1) until the center of a subsequent area (3b) coincides with the axis of rotation (8) of the support structure (1) and fixed again to the support structure (1);
d) the subsequent area (3b) is exposed to the radiation beam (10), forming an information track;
e) steps c) and d) are repeated until all areas (3c, 3d, . . . ) of the series of areas (3) are exposed to the radiation beam (10).

2. A method of manufacturing a stamper according to claim 1, wherein in step c) the master plate (2) is rotated around the axis of rotation (9) of the master plate (2) and the axis of rotation (9) of the master plate (2) is present at a fixed position on the support structure (1).

3. A method of manufacturing a stamper according to claim 2, wherein the master plate (2) is rotated n−1 times an amount substantially equal to 360/n degrees and n is an integer number larger than 1.

4. A method of manufacturing a stamper according to claim 2, wherein the master plate (2) has a diameter in the range of 150-170 mm and the diameter of the areas (3) with spiral- or concentric shaped information tracks is smaller than 40 mm.

5. A method of manufacturing a stamper according to claim 4, wherein n is one of the numbers 8, 9 and 10 and the axis of rotation (9) of the master plate (2) on the support structure (1) has a distance of 30-55 mm to the axis of rotation (8) of the support structure (1).

6. Use of a master plate (2) provided with areas of information tracks according to the method of claim 1 for the manufacture of a stamper having a negative replicated surface of the master plate.

7. A support structure (1) suitable for use in the method according to claim 1, characterized in that the support structure (1) comprises at least one counterweight (5) in order to counterbalance the mass of an attached master plate (2), so that the center of gravity of the assembly of the support structure (1) and the attached master plate (2) substantially coincides with the axis of rotation (8) of the support structure (1).

8. A support structure according to claim 7, characterized in that the counterweight (5) is movable with respect to the axis of rotation (8) of the support structure (1).

9. A support structure according to claim 7, characterized in that the counterweight (5) is detachable from the support structure (1).

10. Use of a stamper, manufactured according to claim 1, for the manufacture of an optical data storage medium with a diameter smaller than 40 mm.
